(19) United States
(12) Patent Application Publication
(10) Pub. No.: US 2013/0308428 A1
(43) Pub. Date: Nov. 21, 2013

(54) CONTAINER FOR STORAGE OF CONTACT LENSES

(71) Applicant: Dale Howard Westcott, Kwa-Zulu Natal (ZA)

(72) Inventor: Dale Howard Westcott, Kwa-Zulu Natal (ZA)

(21) Appl. No.: 13/981,323

(22) PCT Filed: Jan. 24, 2012
(86) PCT No.: PCT/IB12/50317

§ 371 Date: Aug. 6, 2013

(30) Foreign Application Priority Data
Jan. 24, 2011 (ZA) 2010/07511

(51) Int. Cl. G04B 47/02; A45C 11/00

(52) U.S. Cl. CPC G04B 47/02; A45C 11/005
USPC 368/10

(57) ABSTRACT

A container for storing contact lenses is provided, the container comprising at least one receptacle for storing at least one contact lens, a time measuring device to measure a time period corresponding to a use lifetime of a contact lens to be used by a user, and an alerting means, the alerting means being in communication with the time measuring device such that, upon the use lifetime of the contact lens being reached, the alerting means is activated to notify the user to change the contact lens, in a preferred embodiment, the time measuring device is a digital countdown timer. In one embodiment, the container includes a base and a lid, the base defining a zone for accommodating the receptacle. In particular, the receptacle is removably fittable within the zone. Significantly, in a preferred embodiment, the time measuring device is incorporated into the base of the container.

### FIELD OF THE INVENTION

This invention relates to a container for the storage of contact lenses and, in particular, for alerting a wearer when a contact lens' use lifetime has expired.

### BACKGROUND OF THE INVENTION

Contact lenses have become relatively popular, in that not only do they assist users with impaired sight, but they also provide user additional comfort and ease of use.

Contact lenses are typically prescribed either in terms of a 14 day two weekly replacement regime, in which case the lenses need to be replaced after 2 weeks, or a 30 day disposable regime, in which case the lenses need to be replaced after 30 days. In either case, the lens wearer must take the lenses out to clean them every day, and this is typically done by soaking the lenses in lens soaking containers (one per contact lens).

Containers for soaking contact lenses are well known in the art. However, it is an aim of the present invention to provide a contact lens container that not only incorporates an alerting means to alert a user when the lens has reached its use lifetime, thus notifying a user to change or discard his/her contact lens, but that also facilitates the removal and insertion of the lens from/into the wearer's eye.

### SUMMARY OF THE INVENTION

According to the invention, there is provided a container for storing contact lenses, the container comprising:
at least one receptacle for storing at least one contact lens;
a time measuring device to measure a time period corresponding to a use lifetime of a contact lens to be used by a user; and
an alerting means, the alerting means being in communication with the time measuring device such that, upon the use lifetime of the contact lens being reached, the alerting means is activated to notify the user to change the contact lens.

In a preferred embodiment, the time measuring device is a digital countdown timer.

In an embodiment, the container includes calibration means that can be set for 14 or 30 day periods, the setting of the calibration means initiating the countdown of the timer.

In yet another embodiment, the container includes a base and a lid, the base defining a zone for accommodating the receptacle. In particular, the receptacle is removably fittable within the zone. Significantly, in a preferred embodiment, the time measuring device is incorporated into the base of the container.

In an embodiment, the time measuring device is battery operated. In an alternative embodiment, the time measuring device is connectable to an external electrical source either to charge the battery and/or operate the time measuring device.

In a preferred embodiment, the at least one receptacle can hold and store a contact lens fluid.

In an embodiment, the lid is fitted with a mirror.

In an embodiment, the alerting means comprises a visual and/or audio alert.

In yet another embodiment, the container includes tweezers and/or liquid eye refresher sachets and/or spectacles.

### BRIEF DESCRIPTION OF THE DRAWINGS

Embodiments of the invention will now be described, by way of example with reference to the accompanying non-limiting diagrammatic drawings, wherein:

FIG. 1 shows a container for the storing contact lenses according to a preferred embodiment of the invention;

FIG. 2 shows the container of FIG. 1, with receptacles for storing the contact lenses being removable from the container;

FIG. 3 shows the container of FIGS. 1 and 2 in its closed position; and

FIG. 4 is a front cross section view of the container showing elements contained within the container.

### DESCRIPTION OF PREFERRED EMBODIMENTS

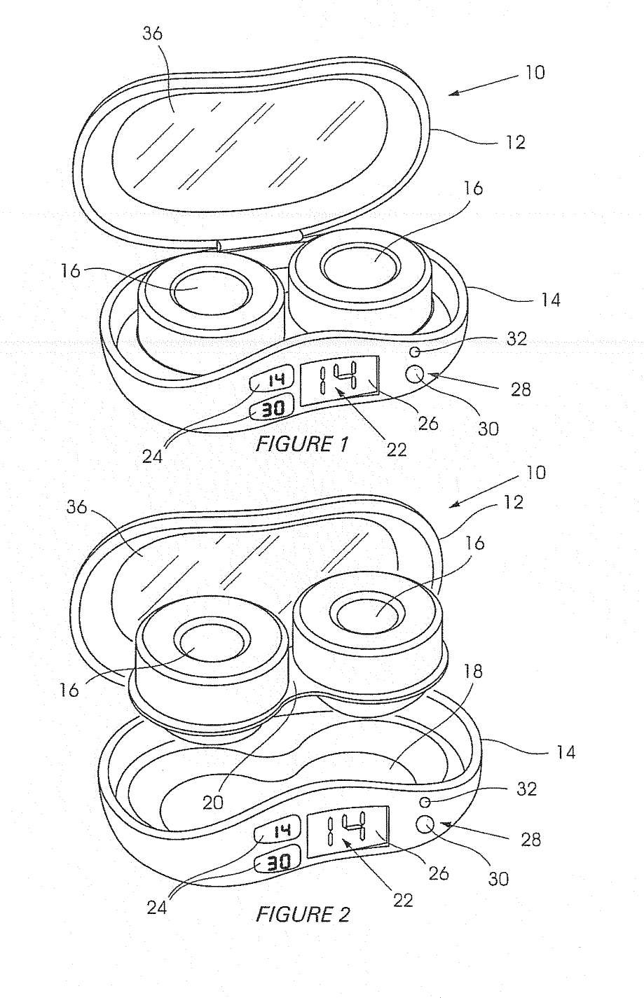

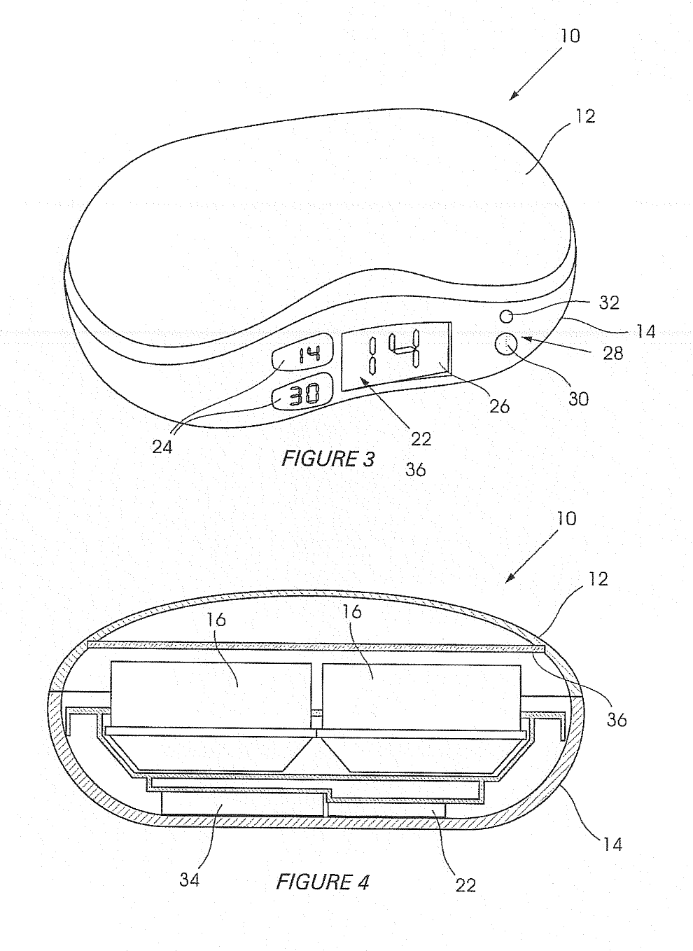

Referring to FIG. 1, a container 10 for storing contact lenses is shown. The container has a lid 12, with the lid 12 being movable from an open position, as depicted in FIGS. 1 and 2, to a closed position, as shown in FIG. 3. In the closed position, the lid 12 closes on a base 14 to define a cavity within the container 10. This cavity can be used to store soaking case receptacles 16 containing, inter alia, contact lens fluid and/or contact lenses, the receptacles being supported by a support frame 17.

In a preferred embodiment, the base 14 defines a zone 18 for accommodating the support frame 20 and receptacles 16 and, in so doing, allowing for the safe storage of the receptacles 16 within the container 10. This further allows for the receptacles 16 to be removable from the container 10, thus granting a user easy and convenient access to the receptacles 16 and their contents, or to replenish the receptacles 16 with fresh contact lenses and/or contact lens fluid.

The container 10, and in particular the base 14, further includes a time measuring device 22. This time measuring device 22 may take a number of forms including, but not limited to, a digital countdown arrangement, mechanical timers, quartz timers or electronic timers. The time measuring device 22 is connected to selectable time period buttons 24 that can be set, according to the user's preference and according to a use lifetime of the contact lenses being used by the selection being made by the user by pressing of one of the time period buttons 24. In these instances, the default time periods are either 14 or 30 days. This time period is consistent with the use lifetime of most continuous use contact lenses, though it is envisaged, with further developments in materials used in contact lenses, that the number of easy choice time period buttons 24 can be increased. Alternatively, although not shown, the time measuring device 22 can include calibration means to allow the user to calibrate the time period so that it corresponds with the use lifetime of the contact lens.

The user can therefore, upon insertion of fresh contact lenses, activate the time measuring device 22 so that the calibrated time period begins to countdown. In this regard, provision is also made for a display 26 connected to the time measuring device 22 to display to the user the selected time period and/or the remaining time left of the countdown time period.

Alerting means 28 is also provided, the alerting means 28 being in communication with the time measuring device 22, such that, upon the lapsing of the selected time period, the alerting means 28 is activated. This resulting alert may be an audible alert, using a buzzer 30, or a visual alert, using a light 32, or a combination of the two. Through the activation of the alert, the user is notified that the use lifetime of the inserted contact lenses has expired and, in order to prevent damage being caused to the user's eyes through continued use of expired contact lenses, the expired contact lenses should be removed and replaced. Provision is also made for a battery 34 or an external power source to power the time measuring device and/or alerting means.

To assist the user in changing contacting lenses, an optically correct glass mirror 36 can be included on the inside of the lid 12. The mirror 36 will assist the user in locating and removing the expired contact lens quickly and safely or, alternatively, in assisting the user to insert fresh contact lenses.

Further provision can be made for storage zones for tweezers and/or eye refresher sachets and/or spectacles. Therefore, in the event that the use lifetime of the contact lens expires at a time when the user does not have a replacement contact lens, the user can use the spectacles as an interim aid.

The invention therefore provides a container for storing contact lenses, with the container including a time measuring means and an alerting means, so that a user can be notified when a use lifetime of the contact lenses has expired. This will help to prevent accidental damage being caused to the user's eyes through contact lenses being used past their use lifetime.

1. A container for storing contact lenses, the container comprising:
at least one receptacle for storing at least one contact lens;
a time measuring device to measure a time period corresponding to a use lifetime of a contact lens to be used by a user; and
an alerting means, the alerting means being in communication with the time measuring device such that, upon the use lifetime of the contact lens being reached, the alerting means is activated to notify the user to change the contact lens.

2. The container of claim 1, wherein the time measuring device is a digital countdown timer.

3. The container of claim 1, wherein the container includes calibration means that can be set for 14 or 30 day periods, the setting of the calibration means initiating the countdown of the timer.

4. The container of claim 1, wherein the container includes a base and a lid, the base defining a zone for accommodating the receptacle.

5. The container of claim 4, wherein the receptacle is removably fittable within the zone.

6. The container of claim 4, wherein the time measuring device is incorporated into the base of the container.

7. The container of claim 1, wherein the at least one receptacle can hold and store a contact lens fluid.

8. The container of claim 1, wherein the lid is fitted with a mirror.

9. The container of claim 1, wherein the alerting means comprises a visual and/or audio alert.

10. A container for storing contact lenses, substantially as herein described and illustrated.
